(19) United States
(12) Patent Application Publication
(10) Pub. No.: US 2004/0164174 A1
(43) Pub. Date: Aug. 26, 2004

(54) Drinking straw and vessel equipment with the same

(76) Inventor: Alan Francis Day, Bromley (GB)

Correspondence Address: ALAN FRANCIS DAY, 3 SANDILAND CRESCENT, BROMLEY, BR2 7DP, GB

(21) Appl. No.: 10/760,160

(22) Filed: Jan. 20, 2004

Related U.S. Application Data
(60) Provisional application No. 60/442,740, filed on Jan. 27, 2003.

(30) Foreign Application Priority Data
Nov. 8, 2003 (GB) GB 0217660.0

(51) Int. Cl. A61J 15/00; B65D 83/00

(52) U.S. Cl. 239/33; 215/229; 215/388; 215/389

(57) ABSTRACT

A drinks straw and vessel equipment of the same g., a novelty feature straw that is while or partly made from thermo-sensitive material and a chamber under vacuum FIG. 612 sealed by membranes at first end (drinking) FIG. 614 and second (distal) end FIG. 616. Straw ends have inwardly projecting integral spikes FIG. 622 mounted on caps that are collapsible and form an open cage to support spike FIG. 622 that can be pressed into said membranes causing spikes to pierce membrane at both ends of straw.

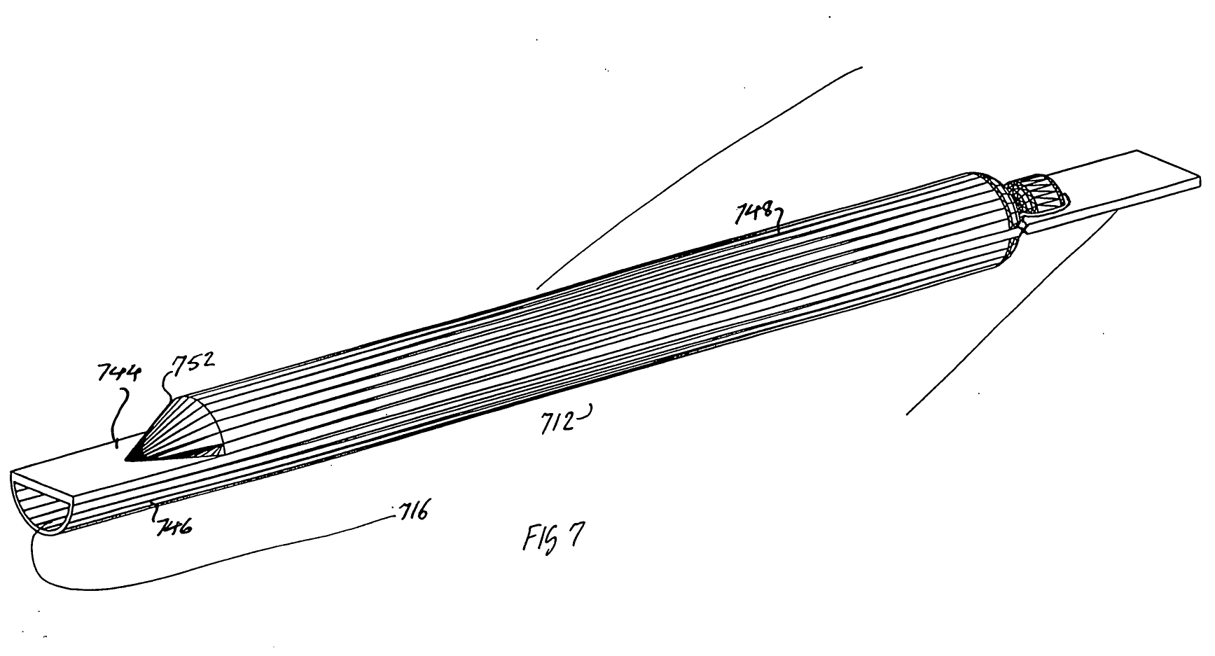

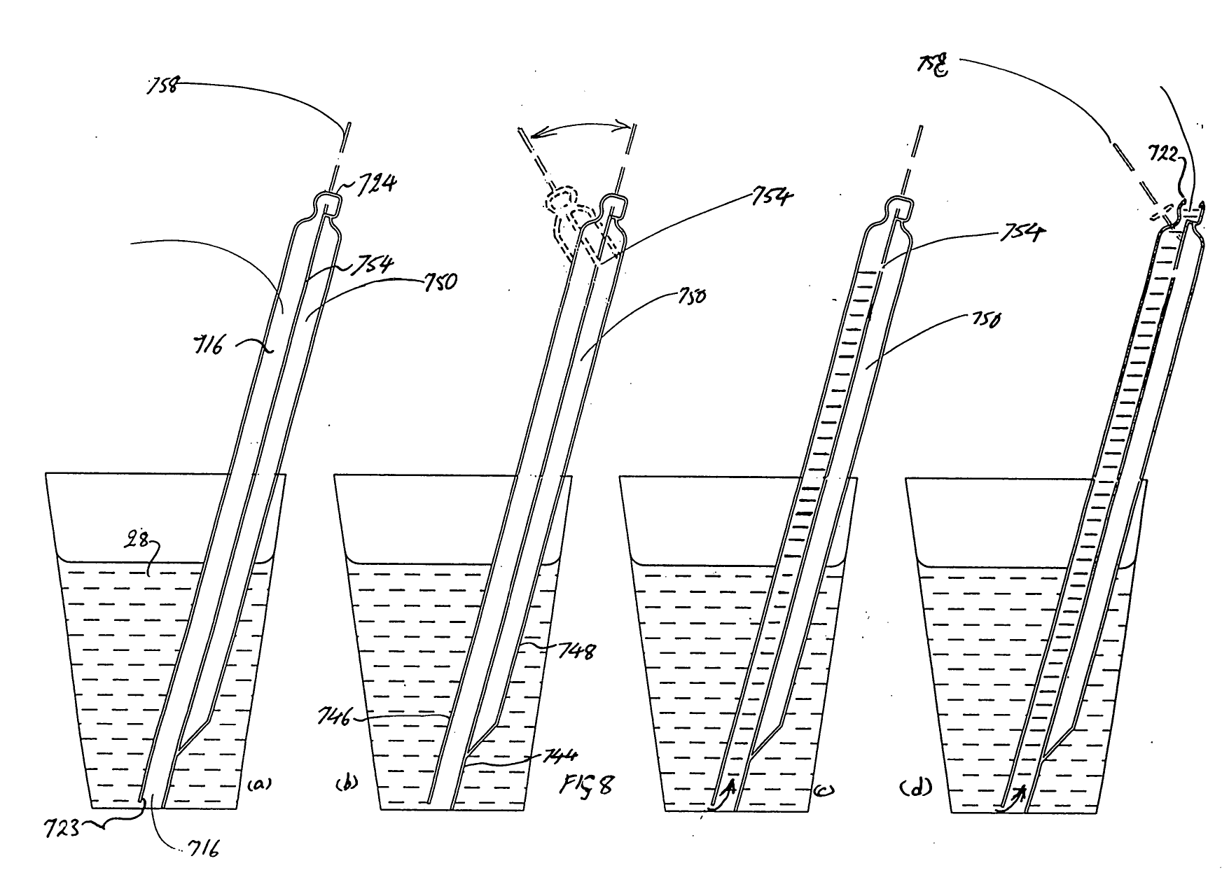

To activation entertainment/novelty feature of straw, user must press bottom of straw cage FIG. 628 against base of a drinking vessel, containing either a chilled or hot liquid. This will result in spike FIG. 622 piercing membrane FIG. 616. That will result in atmospheric pressure forcing liquid into straw body flooding the straw up to membrane FIG. 614 whereby the thermo-sensitive material of straw body will change colour or reveal a hidden image as it comes in direct contact with chilled or hot liquids. After user has been entertained visually by colour or image change they can then press cage at mouth-piece end of straw FIG. 618 to force spike FIG. 622 attached to end wall FIG. 620 to pierce membrane FIG. 614. At this stage liquid from drinks vessel can be consumed through apertures FIG. 626 in a conventional straw fashion. This will result in continued activation of thermo-sensitive material as chilled or hot liquid come into direct contact with straw body.

The present invention relates to a drinking straw and to vessels equipped with a drinking straw.

Drinking straws, typically of plastics material, having a convoluted shape are known to provide a visual attraction for users, particularly children. If the straw is provided with a transparent or translucent wall, the user can observe liquid travelling up and down the convoluted path provided by the straw as liquid is drunk through it.

Straws of this kind have previously been provided separately from vessels in which consumable liquids are supplied or have been attached to the container as a permanent part thereof.

It is further known to supply short straight or cranked straws packaged with cartons of consumable liquid. The straws are put up in sachets of plastics film which are bonded to the sides of respective cartons. There is a continuing need to provide vessels containing consumable liquids with drinking straws packaged therewith in a more convenient manner and/or providing a greater visual appeal to the user when in use than previously.

The present invention provides in a first aspect A drinking straw comprising a first end from which in use a user drinks and a second end for dipping into a liquid to be drunk, a temporary closure at said first end closing the straw, a sealed and at least partially evacuated chamber formed in said straw, the interior of said chamber being closed against fluid communication with the second end of the straw by a user openable closure, whereby when the second end of said straw is dipped in liquid and said user openable closure is opened, vacuum in said chamber draws liquid through said second end of the straw toward said chamber and into a portion of said straw within which said liquid produces a visible change.

The visible change may be due to the liquid being visible by virtue of the transparency or translucency of the material of the straw. Alternatively, the straw may be made from temperature sensitive material such that it changes colour in response to the liquid.

In one preferred type of straw according to the invention, there is provided a drinking straw having a bore defined within a wall member and having a first end and a second end, said straw comprising a portion extending from a location intermediate said ends or at said second end towards said first end, means forming a temporary closure of said bore at said location, and means forming a temporary closure of said bore at the end of said portion remote from said location, said portion being wholly or partially evacuated, and the wall member at least in said portion of the straw being such that when liquids contents are present within the straw, said contents are visible through said wall or otherwise produce a said visible change.

If the second end of such a straw is dipped into a vessel containing liquid, upon release of the temporary closure at said location, the liquid will be driven by overlying pressure (typically atmospheric pressure) to occupy the evacuated portion of the straw. The user will therefore see and may be visually entertained by the flow of liquid into said portion. Upon release of the temporary closure of the portion remote from the said location, the liquid, if consumable, may be drunk through the straw.

The temporary closure of the bore at said location may be formed by a removable clamp compressing the wall member to close the bore. Other forms of temporary closure are however possible such as the use of a plug of material which will dissolve in the liquid after a delay period or which could be melted by the application of heat to which the walls of the straw are sufficiently resistant.

The temporary closure of the bore at said location is formed by an occlusion of the bore of the straw and the wall member adjacent said occlusion has a weakened area at which it is frangible by being bent by the user.

The temporary closure at the end of the first portion remote from said location may be a removable end cap applied to the straw. However, it may take any other forms such as instance an occlusion of the end of the straw such that the end can simply be cut-off by the user or broken-off partially or completely along lines of weakness provided during manufacture.

Said location is intermediate the ends of the straw and divides said portion of the straw from a second portion extending form said location to the second end of the straw.

Optionally, a vent hole is provided through the wall of the straw communicating with its bore in said second portion of the straw adjacent said location. In order for the straw to perform as desired it will be necessary for the second portion to contain liquid, preferably filling the second portion. There are various ways in which the second portion could be filled with liquid including evacuation of the head space of a container into which the second portion is dipped or the use of a needle to fill the second portion with liquid. However, if a vent hole as described is provided, the second portion will spontaneously fill with liquid upon being dipped into a liquid and the vent hole may thereafter be plugged.

In an alternative preferred type of embodiment there is provided a drinking straw comprising a first end from which in use a user drinks and a second end for dipping into a liquid to be drunk, a temporary closure at said first end closing the straw, a sealed and at least partially evacuated chamber formed in said straw, the interior of said chamber being closed against fluid communication with the second end of the straw by a user openable closure, whereby when the second end of said straw is dipped in liquid and said user openable closure is opened, vacuum in said chamber draws liquid through said second end of the straw toward said chamber and into a portion of said straw within which said liquid is visible, which straw has a bore for the passage of liquid to be drunk and wherein said chamber extends side by side with said bore over at least a portion of the length of the straw, and wherein said user openable closure is a frangible seal in a common wall separating said chamber from said bore.

In order to increase the visual appeal of the operation of the straw as the liquid rises up the straw upon release of the temporary closure at said location, it is desirable that the straw is shaped in a convoluted manner such as into a plurality-of coils or loops. For maximum impact, the shape may form alphanumeric characters such as the numeral 2000. A straw so shaped may be used in commemorating the millennium.

The invention extends to a vessel containing a liquid having a straw as described above with the said second end of the straw dipping into said liquid, such that upon release of the temporary closure at said location, liquid is drawn into said portion either by vacuum or suction created by the mouth of the user.

Preferably, such a vessel comprises a bulkhead above said liquid and a storage compartment defined between said bulkhead and a removable cover for said compartment. Where said location is between the ends of the straw, the first portion of said straw may be contained within said storage compartment and the second portion of said straw may pass through an aperture in said bulk-head into said liquid.

Preferably, a liquid-tight seal is provided between the straw and said bulkhead, thus preventing liquid in the vessel passing up into the said compartment.

A breather aperture may be provided in the bulkhead with means forming a removable seal for the breather aperture. This may be provided to facilitate drinking of the contents of the vessel through the straw by allowing air to pass through the breather aperture into the head-space of the vessel as the liquid level falls.

Alternatively, it may be arranged that the seal between the straw and the bulkhead is frangible, perhaps upon movement of the straw, so that a breather aperture is formed when that seal is broken.

However the breather aperture is provided, a removable sealing means may be connected to the removable cover such that upon removal of the cover the breather aperture is unsealed.

Furthermore, the removable cover may be connected to the means forming a temporary closure of the bore of the straw at said location such that removal of said cover releases said temporary closure to allow liquid into said first portion of the straw.

It will be appreciated that the cover need not be removable in the sense of being totally detachable from the vessel. It is sufficient that the cover has a portion which can be opened even if it is connected, for instance at a hinge, to a remaining portion of the cover or to the vessel itself.

Preferably, upon opening of the removable cover, the straw will spontaneously extend itself out of said compartment. This may be achieved if the straw is made from a material having a suitable “memory” and is compressed from an extended position to fit within the said compartment.

In an alternative aspect, the invention provides a vessel containing a liquid and having a drinking straw dipping into said liquid, wherein said vessel comprises a bulkhead above said liquid and a storage compartment defined between said bulkhead and a removable cover for said compartment, a first portion of said straw being contained within said storage compartment and a second portion of said straw passing through an aperture in said bulkhead into said liquid.

A straw packaged in this manner, even if not having the vacuum feature which characterises the straw according to the first aspect of the invention, will be more readily available or use than a straw which is packaged in a sachet attached o the side of a container. Furthermore, the straw may be extendible into an attractive convoluted shape as described above and may therefore have a length which would be impractical if attached to the exterior of the vessel.

However, it is preferred that the straw is in accordance with the first aspect of the invention.

Where an evacuated straw is used, the material from which it is made should be chosen to have sufficient strength to prevent the walls of the straw collapsing.

The vessel itself according to either aspect of the invention may be in the form of a drinks can. The liquid contained within the vessel may be effervescent or still.

The present invention will be further described and illustrated with reference to the accompanying drawings in which:

FIG. 1 shows a cross-sectional view of an embodiment according to the invention comprising a straw packaged within a closed drinks container;

FIG. 2 shows the embodiment of FIG. 1 with the container closure partially opened;

FIG. 3 shows the embodiment of FIGS. 1 and 2 with the container closure fully opened;

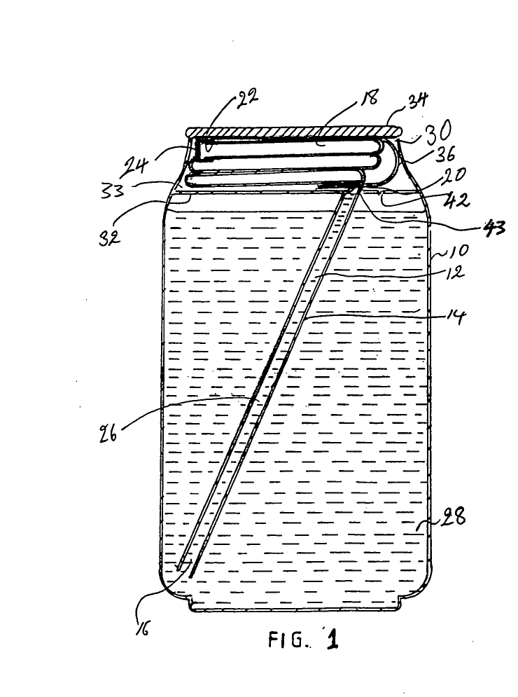

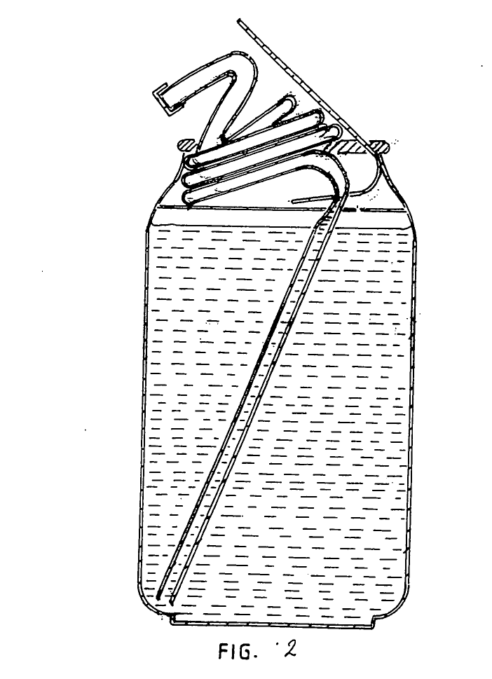

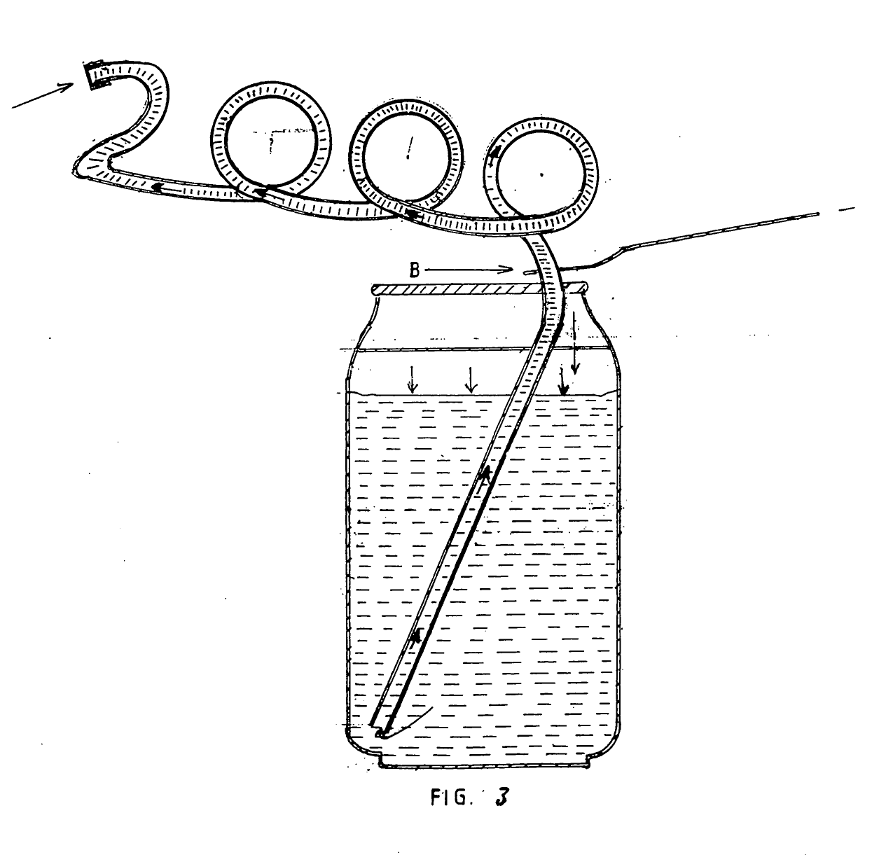

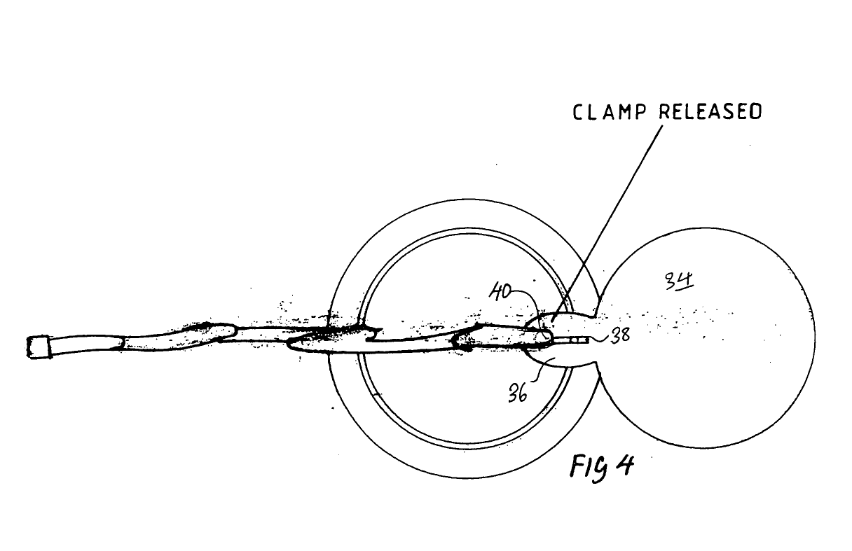

FIG. 4 shows the container in the state of opening shown in FIG. 3 but in plan view;

FIG. 5 shows the embodiment of FIG. 1 with the end closure of the straw removed;

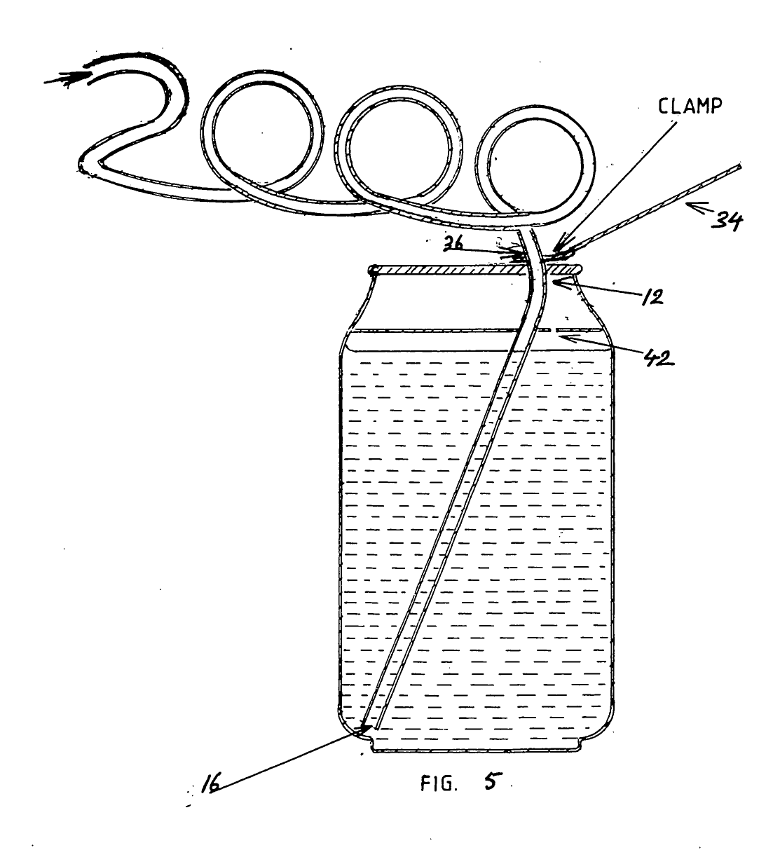

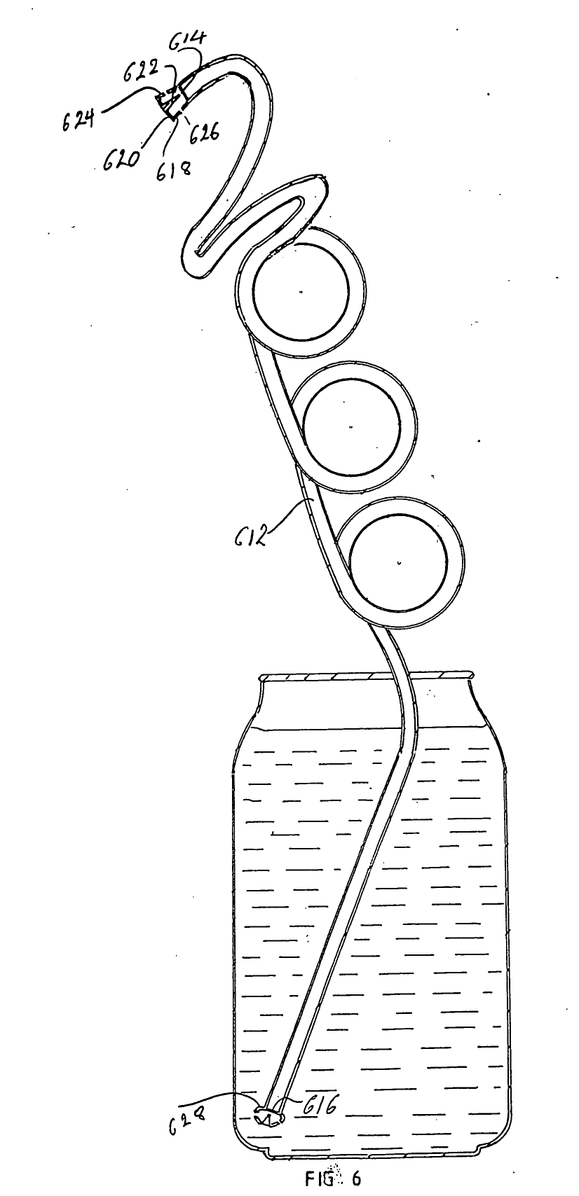

FIG. 6 shows a further embodiment of a straw according to the invention;

FIG. 7 shows in perspective view a further design of straw according to the invention; and

FIG. 8 in views (a) to (d) shows in longitudinal cross section the straw of FIG. 7 at stages in its use.

As shown in FIG. 1, a typical container 10 according to the invention contains a pre-packaged drinking straw 12 having a transparent plastics wall 14 defining a bore 16. A first portion 18 of the straw extends from a temporary closure 20 intermediate the ends of the straw to a proximal end (drinking end) of the straw 22 at which an end cap 24 has been pressed over the end of the straw 22 to seal it in an airtight manner. The bore 16 of the straw in the first portion 18 has been evacuated of air. A second portion 26 of the straw extends from the closure 20 to the distal end of the straw immersed in liquid contents 28 within the container 10. The second portion 26 of the straw is filled with the liquid contents 28 right up to the temporary closure 20.

The container 10 takes the form of a drinks can having a conventional aluminium or steel wall with a closed bottom and an open top 30. A bulkhead 32 extends below the top 30 defining a space 33 within which the first portion of the straw is accommodated below a lid 34 which seals the top 30. Connected to the underside of the lid 34 is a plastics clamping and sealing member taking the form of a tongue 36 attached to the lid 34 and having a slot 38 (FIG. 4) through which the straw 12 passes and in which the walls 14 of the straw 12 are compressed to close the bore of the straw in an airtight manner. The slot 38 has an enlarged portion 40 at its end remote from the lid 34. During opening, the straw comes into the enlarged part 40 of the slot where the walls of the straw spring apart to open the bore of the straw.

In the bulkhead 32 there is small vent aperture 42 over which is sealed a portion of the tongue 36. There is also a large aperture 43 through which the straw passes, and with which the straw makes a liquid-tight seal.

In use, the lid 34 or a frangible portion thereof is pulled up to open the container freeing the first portion 18 of the straw to expand out of the space 33 above the bulkhead 32 as shown in FIG. 3. The material from which the straw is made has been chosen such that it will spring out as shown and in this instance has been shaped with the alphanumeric characters 2000. However, any suitably convoluted shape may be adopted or an otherwise straight straw may merely be coiled up and compressed down into the space above the bulkhead 32.

As it first escapes from the space above the bulkhead 32, the first portion of the straw is empty of liquid. However, the lid 34 is pulled further up to break the seal over the vent aperture 42 and then to pull the slot 38 along the straw until the compressed portion of the straw in the slot escapes into the enlarged portion 40 of the slot. The liquid 28 is then driven by atmospheric pressure to occupy the first portion of the straw to arrive at the situation shown in FIG. 3. The user may now remove the end cap 24 allowing the liquid in the first portion of the straw to fall back into the container and the container is now fully opened and ready for drinking of the contents 28 by the user through the straw.

The container shown in FIG. 1 may be assembled in manufacture in a number of ways. The straw may be assembled first separately by fitting the tongue 36 to close the bore of the straw intermediate its ends. The first portion may then be evacuated and sealed with the cap 24. The second portion may then be filled with liquid, for instance by syringe. Separately, the can may be filled with liquid before the bulkhead 32 is sealed into position. The straw may be passed through aperture 43 in the bulkhead 32 and the tongue 36 may be sealed over the vent aperture 42 either before or after the bulkhead is installed and the lid 34 may then be applied.

Optionally, the upper portion of the can containing the head space above the liquid and the bulkhead 32 may be formed as a separate item which is joined by its wall below the bulkhead 32 to the wall of the can by any suitable technique including by way of example the use of co-operating screw threads.

Alternatively, the can 10 with the bulkhead 32 and the liquid content 28 may be formed first. The straw with both ends open may be passed into the container through the aperture 43 in the bulkhead 32 so that the second portion of the straw spontaneously fills with liquid to the level in the can. Sufficient vacuum may be applied to draw the liquid content up to the level of the bulkhead and the tongue 36 may be slid down the straw from the proximal end (drinking end) with the straw running through the enlarged portion 40 of the slot 38 and the straw may then be pushed up the slot 38 to clamp the straw with the liquid occupying the whole of the second portion thereof. The tongue 36 may be sealed over the aperture 42 and the aperture 43 in the bulkhead 32. Thereafter, the first portion of the straw may be evacuated and the cap 24 may be fitted. Thereafter, the lid 34 may be applied, optionally first being joined to the tongue 36.

In yet another possible mode of assembly, the tongue 36 may be fitted to clamp the intermediate location of the straw and the first portion may then be evacuated and capped. The straw may be fitted through the bulkhead 32 and sealed in position. By applying vacuum above the bulkhead 32, the air in the head space and in the second portion of the straw may be removed and upon release of the vacuum the head space above the liquid and below the bulkhead 32 will refill with air through the vent aperture 42 with liquid occupying the second portion of the straw. The vent aperture 42 may then be sealed with the tongue 36 as before.

Many modifications and variations of the embodiment shown in above described drawings are possible. For instance the straw may pass through a collar in the aperture 43 which forms a liquid-tight seal against the straw. The straw may alternatively have such a collar moulded into it or fixed to it which fits into said aperture as a sealing plug. Many alternative arrangements may also be used for clamping the bore of the straw.

A further embodiment is shown in FIG. 6. Here a transparent plastics straw 612 has at a first (drinking) end a membrane 614 across its bore and a similar membrane 616 at its second (distal) end. A plastics cap 618 is integral with the straw at the first end and has an end wall 620 bearing an inwardly projecting integral spike 622. The cap has collapsible walls 624 pierced by apertures 626 forming a cage structure. A similar cap 628 is provided at the distal end. The straw between the membrane 614, 616 is evacuated. Pressure on the bottom cap 628 produced by pressing the end of the straw on to the bottom of the drinks container collapses the wall 624 so that the spike 622 pierces the membrane 616, allowing the drink to flood the straw up to the membrane 614.

Pressing the cap 618 similarly pierces membrane 614 so that the liquid may be drunk via apertures 626.

The straw may be straight or convoluted as shown.

The container may simply be a drinking glass or cup but a straw of this kind may be packaged in a container having a bulkhead of the kind shown in FIG. 1.

The straw 712 shown in FIGS. 7 and 8 comprises a bore 716 for the passage of liquid 28 which extends from a first or proximal end 722, at which is formed a temporary closure 724, to an open second or distal end 723. The bore of the straw has a semi-circular cross section, as seen in FIG. 7, having a flat wall 744 and a semi-circular section wall 746. An evacuated chamber 750 is formed between the flat wall 744 and a further semi-circular section wall 748. The semi-circular section walls 746 and 748 are of the same radius and together form a circular cross-section wall defining a circular bore divided on a diameter by the flat wall 744. However, semi-circular wall 748 does not extend to the distal end of the straw (although it could) and the distal end of the chamber 750 is closed by a hemi-conical wall 752.

A frangible seal 754 is provided in the wall 744 toward the proximal end of the chamber 750. Bending of the top of the straw as shown in FIG. 8b breaks the frangible seal, opening a communication between the chamber 750 and the bore 716. The vacuum in the chamber 750 then draws liquid up toward the distal end of the straw. In this region at least, the straw is transparent of translucent such that the presence of the liquid produces a visually observable change.

To drink from the straw, the user opens the temporary closure 724. In the illustrated embodiment, a tab 758 is provided which can be bent over to break a cap at the proximal end of the straw which constitutes said temporary closure.

The straw illustrated in FIGS. 7 and 8 may be produced by extruding a double bored straw and then sealing the chamber and bore ends as required, the straw being in a vacuum chamber whilst chamber 750 is sealed. The fold-over tab 758 and the attached cap would have areas of weakness embodied in them during the heat sealing process.

The straw shown is straight but it may be shaped in a visually appealing or dramatic way as described in relation to previous embodiments. It may be made from a temperature sensitive material so that a change in colour occurs when hot or cold liquid enters the upper part of the straw. This could be used to highlight a message or logo on the straw. More than one chamber 750 can be provided as can more than one bore 716.

Many further modifications and variations are possible within the scope of the invention.

1. A drinking straw comprising a first end from which in use a user drinks and a second end for dipping into a liquid to be drunk, a temporary closure at said first end closing the straw, a sealed and at least partially evacuated chamber formed in said straw, the interior of said chamber being closed against fluid communication with the second end of the straw by a user openable closure, whereby when the second end of said straw is dipped in liquid and said user openable closure is opened, vacuum in said chamber draws liquid through said second end of the straw toward said chamber and into a portion of said straw within which said liquid produces a visible change.

2. A drinking straw as claimed in claim 1, having a bore defined within a wall member,
said straw comprising a portion extending from a location intermediate said ends or at said second end towards said first end, said portion constituting said chamber,
means forming said user openable closure of said bore at said location, and the wall member at least in said portion of the straw being such that when liquid contents are present within the straw said contents produce a visible change.

3. A straw as claimed in claim 2, wherein the temporary closure of the bore at said location is formed by a removable clamp compressing said wall member to close said bore.

4. A straw as claimed in claim 2, wherein the temporary closure of the bore at said location is formed by an occlusion of the bore of the straw and the wall member adjacent said occlusion has a weakened area at which it is frangible by being bent by the user.

5. A straw as claimed in any one of claims 2 to 4, wherein said location is intermediate the ends of the straw and divides said portion of the straw from a second portion extending from said location to the second end of the straw.

6. A straw as claimed in claim 5, wherein a vent hole is provided through said wall communicating with said bore in said second portion of the straw adjacent said location.

7. A straw as claimed in claim 1, having a bore for the passage of liquid to be drunk and wherein said chamber extends side by side with said bore over at least a portion of the length of the straw, and wherein said user openable closure is a frangible seal in a common wall separating said chamber from said bore.

8. A straw as claimed in any preceding claim, wherein said portion of said straw in which said liquid is visible is shaped to include a plurality of coils or loops.

9. A straw as claimed in claim 8, wherein said coils or loops form alphanumeric characters.

10. A straw as claimed in any preceding claim, wherein the temporary closure at the first end of said straw is formed by a removable end cap applied to said straw.

11. A vessel containing a liquid having a straw as claimed in any preceding claim with said second end dipping into said liquid, such that upon opening of the user openable closure of said chamber, liquid is drawn into said portion in which it is visible.

12. A straw as claimed in claim 1, having a bore or bores for the passage of liquid to be drunk and wherein said chamber or chambers extend side by side over at least the length of the straw, and wherein said bore or bores are allowed free flow passage of liquid providing the natural tension present in the straw is opposed to release the twist or kink within the straw which prevents passage of liquid. Releasing this tension will ensure that an air tight seal will prevent the liquid drawn up the straw by normal mouth suction, can not return to its normal level when influenced by gravity. It would also be possible to incorporate or add a one-way flap or valve within the straw to achieve the same effect.
A vessel as claimed in claim 11, said vessel comprises a bulkhead above said liquid and a storage compartment defined between said bulkhead and a removable cover for said compartment, the said portion of said straw into which the liquid is drawn being at least partially contained within said storage compartment and the straw passing through an aperture in said bulkhead into said liquid.

13. A vessel as claimed in claim 12, wherein a liquid tight seal is provided between said straw and said bulkhead.

14. A vessel as claimed in claim 12 or claim 13, wherein a breather aperture is provided in said bulkhead with means forming a removable seal for said breather aperture.

15. A vessel as claimed in claim 14, wherein said removable seal means is connected to said removable cover such that removal of said cover unseals said breather aperture.

16. A vessel as claimed in any one of claims 12 to 15, wherein said removable cover is connected to the user openable closure of the compartment of the straw such that removal of said cover opens said user openable closure to allow liquid into said portion of the straw in which it is visible.

17. A vessel as claimed in any one of claims 12 to 16, wherein upon removal of the removable cover, the straw spontaneously extends itself out of said compartment.

18. A vessel containing a liquid and having a drinking straw dipping into said liquid, wherein said vessel comprises a bulkhead above said liquid and a storage compartment defined between said bulkhead and a removable cover for said compartment, a first portion of said straw being contained within said storage compartment and a second portion of said straw passing through an aperture in said bulkhead into said liquid.

19. A vessel as claimed in claim 18, wherein the drinking straw is as claimed in any one of claims 1 to 12.
